(19) United States
(12) Patent Application Publication
(10) Pub. No.: US 2026/0094243 A1
(43) Pub. Date: Apr. 2, 2026

(54) GENERATIVE ARTIFICIAL INTELLIGENCE SUPPORTING IMAGE AND DOCUMENT ENHANCEMENTS FOR TRAINING MODELS USING QUANTUM COMPUTING

(71) Applicant: Bank of America Corporation, Charlotte, NC (US)

(72) Inventors: Harinath Meedinti Bhaskara Reddy, Charlotte, NC (US); Manu Kurian, Dallas, TX (US); Michael G. Horstman, Red Bank, NJ (US)

(21) Appl. No.: 18/894,122

(22) Filed: Sep. 24, 2024

(51) Int. Cl. G06T 5/60; G06N 10/20; G06N 10/60

(52) U.S. Cl. CPC G06T 5/60; G06N 10/20; G06N 10/60

(57) ABSTRACT

A system for the enhancement of a digital image using quantum computing to provide an organization with the enhanced digital image for further use. A quantum computer may be configured to receive digital images that include pixels, determine whether the digital images comprise a PPI that is below a PPI threshold, convert the pixels of the digital image into qubits of the digital image when below the PPI threshold, use quantum superposition properties and/or quantum entanglement properties of qubits to propose additional pixels for enhancement of the digital image, and run a GenAI model to confirm the accuracy of the additional pixels proposed to enhance the digital image. Upon receiving confirmation from the GenAI model, add the additional pixels to enhance the digital image to exceed the PPI threshold, and provide the converted digital image to the organization.

Aspects of the disclosure relate to the use of quantum computing and GenAI to enhance the quality of digital scans, electronic documents, and/or digital images.

### BACKGROUND

Organizations may receive and store substantial quantities of documents and data. As the world becomes digital, it may be important to be able to extract information from these documents digitally. There may be an emphasis on converting these documents into a digital format, such as by scanning the documents with an image scanner.

Unfortunately, not all the documents may have a sufficient quality and/or clarity that provide image scans that can provide information digitally. Furthermore, sometimes electronic documents may have missing information. The missing information may render the remaining information in the document less useful.

Additionally, sometimes digital images may have a low pixel density giving the image a pixelated appearance. Pixelated may describe digital images in which individual pixels are discernable.

There may be a need to provide improved quality digital scans such as digital scans that include erroneous pixels and/or are missing pixels. The erroneous pixels and/or are missing pixels may be a result of a starting document containing those errors. The erroneous pixels and/or missing pixels may be a result of an ineffective scan of the starting document. There is a need to provide improved completeness of electronic documents that contain erroneous information and/or missing information. There is a need to provide improved pixel density for digital images that have a pixel density below a pixel density threshold.

### SUMMARY

It may be an object of the disclosure to provide systems and methods for improving the quality of a digital scan of documents such as by correcting an erroneous pixel and/or replacing a missing pixel. It may be an object of the disclosure to provide systems and methods for improving completeness of electronic documents that contain erroneous information and/or are missing information. It may be an object of the disclosure to provide systems and methods for improving pixel density for digital images that have a pixel density below a pixel density threshold.

Apparatus and methods may provide for enhancement of electronic documents using quantum computing to support training an artificial intelligence (“AI”) model. Apparatus may include a quantum computer. The quantum computer may be used to enhance electronic documents for use in training an AI model. AI models may be trained by feeding them large amounts of data and using a variety of techniques to help them learn and improve their performance. Disclosed apparatus and methods may contribute to supplying large amounts of data to training an AI model.

Apparatus may include a generative artificial intelligence (“GenAI”) model. The GenAI model may provide confirmation of accuracy of enhancements made to electronic documents by the quantum computer. The GenAI model may use its computing power to understand how similar digital scans, electronic documents, and digital images are constructed, and contrast a current example to historical comparators. The GenAI model may utilize natural language processing (“NLP”) to understand how documents of a similar nature are typically populated. The GenAI model may then learn to extrapolate when data is erroneous and/or missing from document, digital scan of the document, and/or electric document.

The quantum computer may be configured to enhance electronic documents when the electronic documents include a quality that is below a quality threshold. A quality that is below the quality threshold may include the electronic document including an erroneous character and/or a missing character. Enhancing electronic documents may include correcting a corrupt character and/or a missing character for each electronic document.

An electronic document may include a word processing document. An electronic document may include a portable document format (“PDF”). An electronic document may include a spreadsheet.

The quantum computer may be configured to receive electronic documents. Electronic documents may include characters.

The quantum computer may be configured to determine whether the electronic documents include a quality that is below the quality threshold. For electronic documents with a quality that is below the quality threshold, the quantum computer may be configured to convert the characters of the electronic document into quantum bits (“qubits”) of the electronic document. The quantum computer may be configured to propose, using quantum superposition properties and/or quantum entanglement properties of qubits, characters to enhance a quality of the electronic document.

The quantum computer may be configured to run a generative artificial intelligence (“GenAI”) model to confirm an accuracy of the characters proposed to enhance the quality of the electronic document using quantum superposition properties and/or quantum entanglement properties of qubits. When the GenAI model provides confirmation and/or when receiving confirmation from the GenAI model, the electronic document with a quality that is below the quality threshold may be converted into an electronic document with a quality that is above the quality threshold. This may be accomplished by updating the electronic document with the characters proposed using quantum superposition properties and/or quantum entanglement properties of qubits.

When the electronic document has a quality that is above the quality threshold, the electronic document may be free of corrupt characters and missing characters. The quantum computer may be configured to provide electronic documents converted from a quality that is below the quality threshold to a quality that is above the quality threshold to train the AI model. The identification of missing characters in an electronic document may contribute to a forensic analysis of the document.

The AI model may be a different model than the GenAI model. The AI model may include the GenAI model. The AI model may include a different GenAI model. The GenAI model may include a generative adversarial network (“GAN”) model. The GenAI model may include a variational autoencoders (VAE) model. The GenAI model may include a diffusion model. The GenAI model may include a combination of the previously mentioned models.

The quantum computer may further include maintenance of a log of changes made to an electronic document. The quantum computer may revert to a previous version of the electronic document when an error is discovered by the GenAI model.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative flow diagram for adding pixels to a digital scan in accordance with principles of the disclosure;

FIG. 2 shows an illustrative flow diagram for adding characters to an electronic document in accordance with principles of the disclosure;

FIG. 3 shows an illustrative flow diagram for increasing the pixels per inch (“PPI”) in a digital image in accordance with principles of the disclosure;

FIG. 4 shows an illustrative block diagram in accordance with principles of the disclosure; and

FIG. 5 shows an illustrative block diagram in accordance with principles of the disclosure.

### DETAILED DESCRIPTION

Organizations may archive records electronically by creating digital scans of documents. When the document includes incorrect information or missing information, the digital scan of the document may propagate those errors. Even when the information in the documents is whole and correct, the act of scanning the documents to make digital scans may introduce error. The digital scans may include pixels. The characters in the documents may include pixels in the digital scan. Errors in the digital scan may include incorrect pixels and missing pixels. Incorrect and missing pixels may correspond to incomplete information in understanding the contents of the scanned documents.

A pixel may be the smallest addressable element in a digital image or digital scan. Each pixel may be a sample of the original scanned document. The more samples that are taken may result in a more accurate representation of the original image. PPI may be a gauge of the measurement density of the digital image. The higher the PPI may result in a more accurate digital scan.

An incorrect, corrupt, or missing pixel may be caused by a starting document that itself contains incorrect, corrupt, or missing information. An incorrect, corrupt, or missing pixel may be caused by an equipment error during a scan.

Digital scans that are missing information may have little value to the organization. For example, digital scans may have little value when optical character recognition (“OCR”) is not successful at recognizing the characters and/or the pixels in digital scans. OCR is a technology that may convert text found in digital images such as scanned documents into a machine-readable format. Inability to use OCR to read the digital scan and/or hard-copy documents may reduce the value of archived documents to an organization.

The noise may be manifested in corrupt and/or missing pixels in the digital scan. For corrupted or missing pixels, quantum computing may be used to predict the correct value of the pixels. For example, contents of the digital scan may be converted to qubit. The superposition and/or entanglement of the qubits may be utilized to compute a prediction of the correct value for the pixels. The quantum computer may propose the value of the missing pixels and/or qubits. Quantum superposition and/or entanglement may determine the missing pixels.

Quantum computing may use quantum mechanics to solve complex problems faster than classical computers. Classic computers may use bits. Quantum computers may use qubits to process information in a different way than classical computers. A unique property about qubits is that they may exist in a superposition of one and zero at the same time, while classical bits may always be one or zero. Additionally, quantum computers may entangle multiple qubits, meaning that changes to one qubit may directly impact the other.

A GenAI model may be used to confirm the predictions of the quantum computer. The data generated by the predictions of the quantum computer may also be used to train an AI model and/or a GenAI model. The training of the AI and/or GenAI model may take place using the quantum computer, on a graphics processing unit (“GPU”), and/or a central processing unit (“CPU”).

Apparatus and methods may include use in forensic analysis of documents and/or digital scans that are missing data. A log may be maintained that includes changes made so it is clear what changes were made by the quantum computing and approved by the GenAI model. Simultaneous logging may allow for reverted to previous version if needed due to an incorrect edit by the quantum computer.

Apparatus and methods may include use in purposefully changing an image. The purposeful change may be done using photoshop. The quantum computer may be used to purposefully change an image. Superposition and/or entanglement of qubits may be utilized to compute a prediction of the correct value for the pixels. Purposefully changing an image may provide an organization with customized digital images. The organization may build a theme from a digital image. Building their own digital images may save them time, effort, and/or money of seeking the digital image elsewhere such as online. Creating the image within the organization allows for freely working with the digital image and/or modifying it.

Apparatus and methods may provide for enhancement of digital scans using quantum computing to support training an artificial intelligence (“AI”) model. Apparatus may include a quantum computer. The quantum computer may be used to enhance digital scans to prepare the digital scans for use in training an AI model. Apparatus may include a GenAI model. The GenAI model may provide confirmation and/or when the quantum computer may receive confirmation from the GenAI model of accuracy of enhancements made to digital scans by the quantum computer.

The quantum computer may be configured to enhance digital scans when the digital scans include a corrupt pixel and/or a missing pixel for each digital scan. Enhancing the digital scans may include correcting the corrupt pixel and/or the missing pixel for each digital scan. The quantum computer may be configured to receive digital scans. The digital scans may include pixels.

The quantum computer may be configured to determine whether the digital scans include a corrupt pixel and/or a missing pixel. For digital scans that include a corrupt pixel and/or a missing pixel, the quantum computer may be configured to convert the pixels of the digital scan into qubits of the digital scan. The quantum computer may be configured to propose, using quantum superposition properties and/or quantum entanglement properties of qubits, pixels to enhance the digital scan.

The quantum computer may be configured to run a GenAI model to confirm the accuracy of the pixels proposed to enhance the quality of the digital scan using quantum superposition properties and/or quantum entanglement properties of qubits. When the GenAI model provides confirmation, the digital scan with a corrupt pixel and/or a missing pixel may be converted into a digital scan that includes no corrupt pixels and no missing pixels by updating the digital scan with the one or more pixels proposed using quantum superposition properties and/or quantum entanglement properties of qubits.

After updating one or more digital scans with one or more pixels, the quantum computer may be configured to provide the digital scans that include no corrupt pixels and no missing pixels to train the AI model. The identification of missing pixels in a digital scan may contribute to a forensic analysis of the document.

The AI model may be a different model than the GenAI model. The AI model may include the GenAI model. The AI model may include a different GenAI model. The GenAI model may include a generative adversarial network (“GAN”) model. The GenAI model may include a variational autoencoders (VAE) model. The GenAI model may include a diffusion model. The GenAI model may include a combination of the previously mentioned models.

The quantum computer may further include maintenance of a log of changes made to a digital scan. The quantum computer may revert to a previous version of the digital scan when an error is discovered by the GenAI model.

Apparatus and methods may provide for enhancement of digital images using quantum computing to provide to an organization an enhanced digital image. The enhanced digital image may be utilized by the organization for a variety of uses. For example, the digital image may be used in printed and/or electronically available material published by the organization. The digital image may be used in education and/or tutorial materials distributed internally in the organization. The digital image may be used as clip art in a variety of applications. The digital image may be used as a theme for developing various content to be used externally and/or internally in an organization. The digital image may be further manipulated in a photoshop application.

The apparatus may include a quantum computer. The quantum computer may be used to enhance digital images to prepare the digital images for further use. Apparatus may include a GenAI model. The GenAI model may provide confirmation of accuracy of enhancements made to digital images by the quantum computer.

The quantum computer may be configured to enhance digital images when the digital images include a pixels per inch (“PPI”) measurement that is less than a PPI threshold. Enhancing the digital images may include increasing PPI by adding pixels to a digital image. The quantum computer may be configured to receive digital images. The digital images may include pixels.

The quantum computer may be configured to determine whether the digital images include a PPI that is below the PPI threshold. For each digital image that includes a PPI that is below the PPI threshold, the quantum computer may be configured to convert the pixels of the digital image into qubits of the digital image. The quantum computer may be configured to propose, using quantum superposition properties and/or quantum entanglement properties of qubits, additional pixels to enhance the PPI of the digital image.

Higher PPI may lead to better digital scan, electronic document, and/or digital image clarity. Lower resolution images may contain larger pixels in fewer numbers that may create a blocky, granular effect, which may also be referred to as ‘pixelated.’ Higher resolution levels may benefit from greater numbers of smaller pixels which may create smoothness, enhanced depth, and clarity.

The quantum computer may be configured to run a GenAI model to confirm the accuracy of the pixels proposed to enhance the PPI of the digital image using quantum superposition properties and/or quantum entanglement properties of qubits. When the GenAI model provides confirmation and/or when receiving confirmation from the GenAI model, the digital image with a PPI that is below the PPI threshold may be converted into a digital image with a PPI that is above the PPI threshold. Exceeding the PPI threshold may be achieved by updating the digital image with additional pixels proposed using quantum superposition properties and/or quantum entanglement properties of qubits.

After updating one or more digital images with one or more additional pixels, the quantum computer may be configured to provide the organization with digital images that are above the PPI threshold. The identification of missing characters in a digital image may contribute to a forensic analysis of the document.

The GenAI model may include a generative adversarial network (“GAN”) model. The GenAI model may include a variational autoencoders (VAE) model. The GenAI model may include a diffusion model. The GenAI model may include a combination of the previously mentioned models.

The quantum computer may further include maintenance of a log of changes made to a digital image. The quantum computer may revert to a previous version of the digital image when an error is discovered by the GenAI model.

The improvement to the digital image may include increasing the PPI of the digital image to be above the PPI threshold. The PPI threshold may include 68 PPI, 92 PPI, 145 PPI, 175 PPI, 195 PPI, 235 PPI, 195 PPI, 295 PPI, 395 PPI, 495 PPI, and/or 595 PPI. A PPI of the digital image may include 72 PPI, 100 PPI, 180 PPI, 200 PPI, 240 PPI, 300 PPI, 400 PPI, 500 PPI, and/or 600 PPI. The PPI of the digital image may include 72 PPI. The PPI of the digital image may include 180 PPI. The PPI of the digital image may include 300 PPI.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized, and that structural, functional, and procedural modifications may be made without departing from the scope and spirit of the present disclosure.

The steps of methods may be performed in an order other than the order shown or described herein. Embodiments, such as apparatus and/or methods, may omit steps shown and/or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

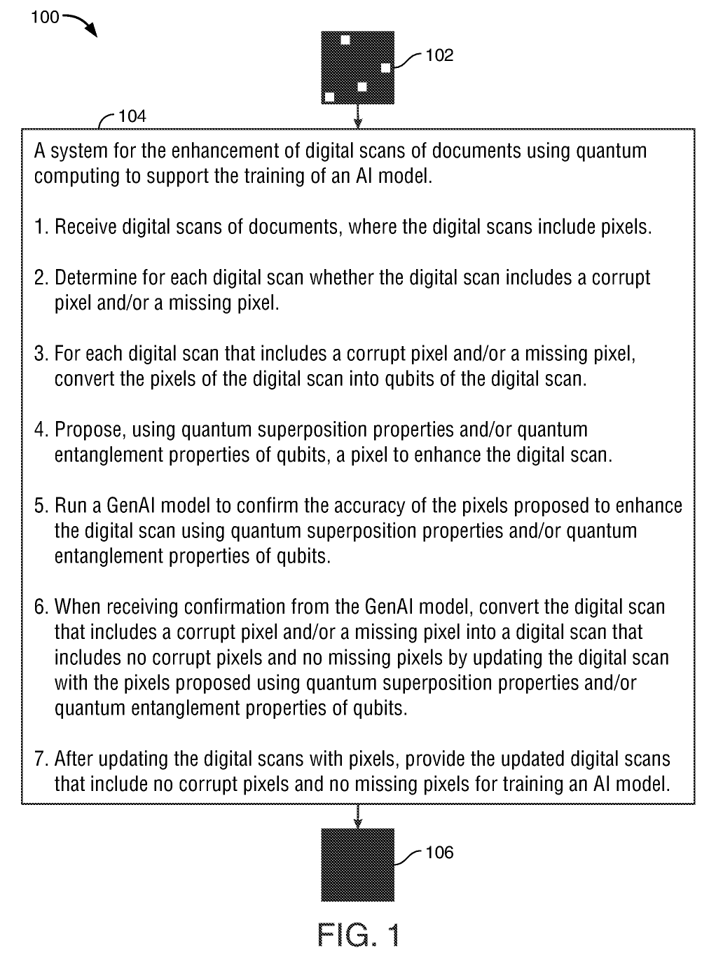

FIG. 1 shows illustrative block diagram 100. Illustrative block diagram 100 may show a system for the enhancement of digital scans of documents using quantum computing to support the training of an AI model. The system may include digital scan 102. Digital scan 102 may include pixels.

Quantum computer 104 may be configured to receive digital scan 102. Quantum computer 104 may be configured to enhance digital scan 102 such that the digital scan may support the training of an AI model.

Quantum computer 104 may be configured to determine for each digital scan whether the digital scan includes a corrupt pixel and/or a missing pixel. Quantum computer 104 may be configured to, for each digital scan that includes a corrupt pixel and/or a missing pixel, convert the pixels of the digital scan into qubits of the digital scan.

Quantum computer 104 may be configured to propose, using quantum superposition properties and/or quantum entanglement properties of qubits, pixels to enhance the digital scan. Quantum computer 104 may be configured to run a GenAI model to confirm the accuracy of the pixels proposed to enhance the digital scan using quantum superposition properties and/or quantum entanglement properties of qubits.

Quantum computer 104 may be configured to, when receiving confirmation from the GenAI model, convert the digital scan that includes a corrupt pixel and/or a missing pixel into a digital scan that includes no corrupt pixels and no missing pixels by updating the digital scan with the pixels proposed using quantum superposition properties and/or quantum entanglement properties of qubits.

Quantum computer 104 may be configured to, after updating a digital scan with pixels, provide digital scan 106 that may be updated to include no corrupt pixels and no missing pixels for training an AI model.

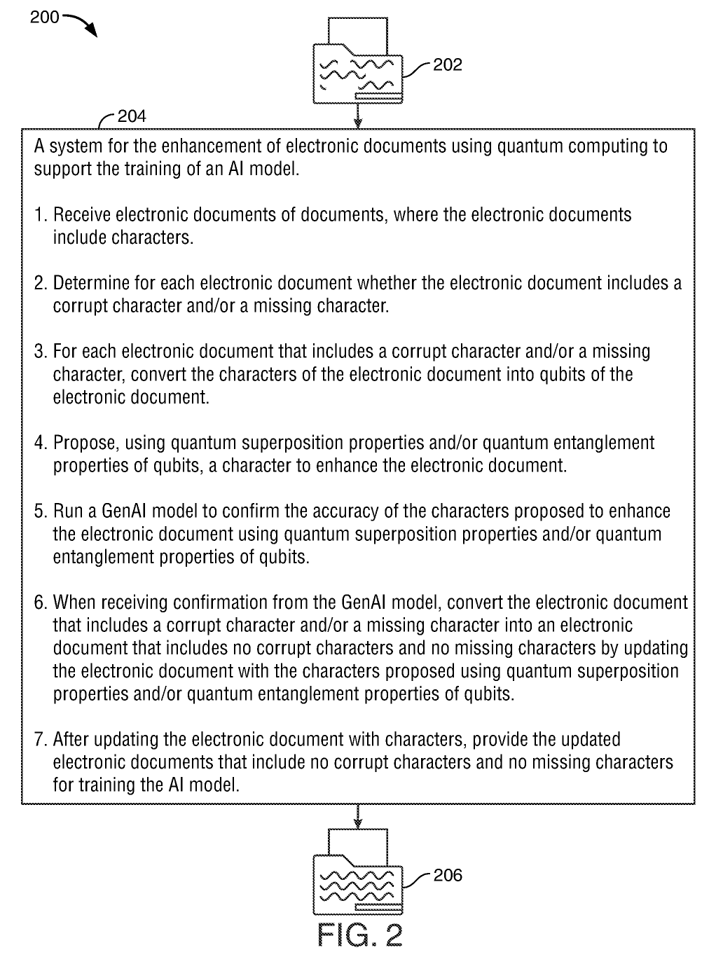

FIG. 2 shows illustrative block diagram 200. Illustrative block diagram 200 may show a system for the enhancement of electronic documents using quantum computing to support the training of an AI model. The system may include electronic document 202. Electronic document 202 may include pixels.

Quantum computer 204 may be configured to receive electronic document 202. Quantum computer 204 may be configured to enhance electronic document 202 such that the electronic document may support the training of an AI model.

Quantum computer 204 may be configured to determine for each electronic document whether the electronic document includes a corrupt character and/or a missing character. Quantum computer 204 may be configured to, for each electronic document that includes a corrupt character and/or a missing character, convert the characters of the electronic document into qubits of the electronic document.

Quantum computer 204 may be configured to propose, using quantum superposition properties and/or quantum entanglement properties of qubits, characters to enhance the electronic document. Quantum computer 204 may be configured to run a GenAI model to confirm the accuracy of the characters proposed to enhance the electronic document using quantum superposition properties and/or quantum entanglement properties of qubits.

Quantum computer 204 may be configured to, when receiving confirmation from the GenAI model, convert the electronic document that includes a corrupt character and/or a missing character into an electronic document that includes no corrupt character and no missing character by updating the electronic document with the character proposed using quantum superposition properties and/or quantum entanglement properties of qubits.

Quantum computer 204 may be configured to, after updating an electronic document with characters, provide electronic document 206 that may be updated to include no corrupt characters and no missing characters for training an AI model.

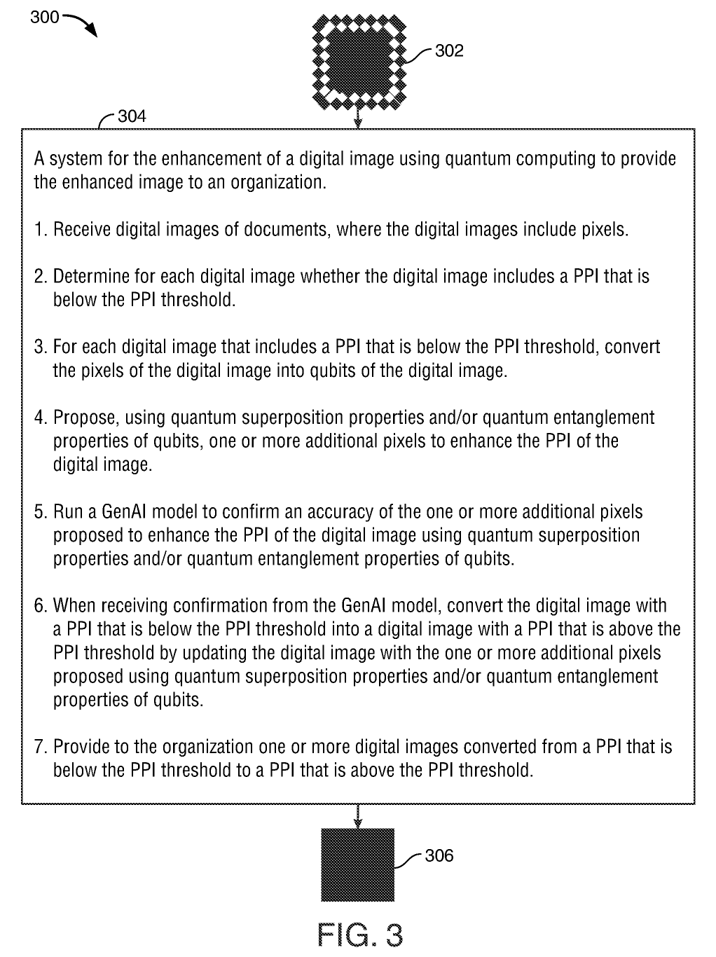

FIG. 3 shows illustrative block diagram 300. Illustrative block diagram 300 may show a system for the enhancement of digital images of documents using quantum computing to provide the enhanced image to an organization. The system may include digital image 302. Digital image 302 may include pixels.

Quantum computer 304 may be configured to receive digital image 302. Quantum computer 304 may be configured to enhance digital image 302 such that the digital image may be utilized by the organization for a variety of uses. For example, the digital image may be used in printed and/or electronically available material published by the organization. The digital image may be used in education and/or tutorial materials distributed internally in the organization. The digital image may be used as clip art in a variety of applications. The digital image may be used as a theme for developing various content to be used externally and/or internally in an organization. The digital image may be further manipulated in a photoshop application.

Quantum computer 304 may be configured to determine for each digital image whether the digital image includes a PPI that is below the PPI threshold. Quantum computer 304 may be configured to, for each digital image that includes a PPI that is below the PPI threshold, convert the pixels of the digital image into qubits of the digital image

Quantum computer 304 may be configured to propose, using quantum superposition properties and/or quantum entanglement properties of qubits, one or more additional pixels to enhance the PPI of the digital image. Quantum computer 304 may be configured to run a GenAI model to confirm the accuracy of the additional pixels proposed to enhance the PPI of the digital image using quantum superposition properties and/or quantum entanglement properties of qubits.

When receiving confirmation from the GenAI model, quantum computer 304 may be configured to convert the digital image with a PPI that is below the PPI threshold into a digital image with a PPI that is above the PPI threshold. Quantum computer 304 achieves the increase in PPI by updating the digital image with the one or more additional pixels proposed using quantum superposition properties and/or quantum entanglement properties of qubits. Quantum computer 304 may be configured to, after updating a digital image with the additional pixels, provide digital image 306 that may be updated to include a PPI that is above the PPI threshold.

The improvement to the digital image may include increasing the PPI of the digital image to be above the PPI threshold. The PPI threshold may include 68 PPI, 92 PPI, 145 PPI, 175 PPI, 195 PPI, 235 PPI, 195 PPI, 295 PPI, 395 PPI, 495 PPI, and/or 595 PPI.

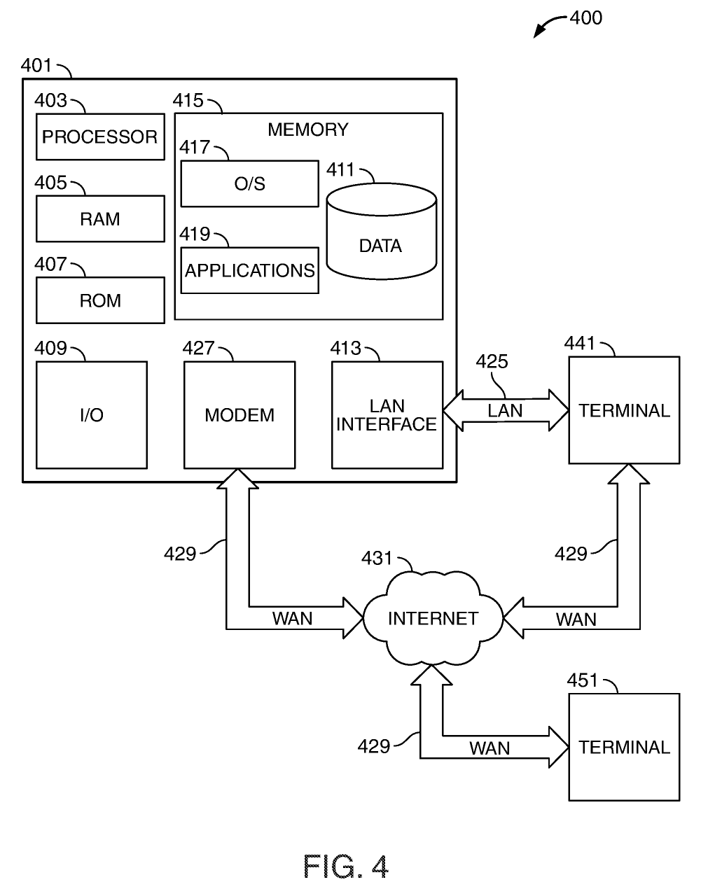

FIG. 4 shows illustrative block diagram 400. Illustrative block diagram 400 may show an illustrative block diagram of apparatus 400 that includes a computer or computer system 401. Apparatus 400 may include one or more features of the apparatus shown in FIGS. 1-4 . Computer 401 may alternatively be referred to herein as a “computing device” or “computing system”. Computer 401 may be a quantum computer or part of a quantum computer. Elements of apparatus 400, including computer 401, may be used to implement various aspects of the apparatus and methods disclosed herein. A “user” of apparatus 400 or computer 401 may include other computer systems or servers or computing devices, such as the program described herein.

Computer 401 may have one or more “N”-qubit processors as well as standard microprocessors 403 for controlling the operation of the device and its associated components, and may include RAM 405, ROM 407, input/output module 409, and a memory 415. The processors 403 may also execute all software running on the computer 401—e.g., the operating system 417 and applications 419. The processors 403 may establish quantum entanglement between qubits such as qubits in different locations. The processors 403 may run QEC. QEC may maintain coherence between entangled qubits. The processors 403 may establish correlation between qubits in different locations. Other components commonly used for computers, such as EEPROM or Flash memory or any other suitable components, may also be part of the computer 401.

The memory 415 may be comprised of any suitable permanent storage technology—e.g., a hard drive or other non-transitory memory. The ROM 407 and RAM 405 may be included as all or part of memory 415. The memory 415 may store software including the operating system 417 and application(s) 419 along with any other data 411 (e.g., historical data, configuration files) needed for the operation of the apparatus 400. Memory 415 may also store applications and data. Alternatively, some or all of computer executable instructions (alternatively referred to as “code”) may be embodied in hardware or firmware (not shown). The microprocessor 403 may execute the instructions embodied by the software and code to perform various functions.

Memory 415 may store data as quantum states. Data may be transferred between qubits through quantum entanglement. Data may be stored on qubits as quantum states that are correlated to quantum states on other qubits. Data may be transferred between qubits through quantum entanglement.

The network connections/communication link may include a local area network (LAN) and a wide area network (WAN or the Internet) and may also include other types of networks. When used in a WAN networking environment, the apparatus may include a modem or other means for establishing communications over the WAN or LAN. The modem and/or a LAN interface may connect to a network via an antenna. The antenna may be configured to operate over Bluetooth, wi-fi, cellular networks, or other suitable frequencies.

Any memory may be comprised of any suitable permanent storage technology—e.g., a hard drive or other non-transitory memory. The memory may store software including an operating system and any application(s) along with any data needed for the operation of the apparatus. The data may also be stored in cache memory, or any other suitable memory.

An input/output (“I/O”) module 409 may include connectivity to a button and a display. The input/output module may also include one or more speakers for providing audio output and a video display device, such as an LED screen and/or touchscreen, for providing textual, audio, audiovisual, and/or graphical output.

In an embodiment of the computer 401, the processor or processors 403 may execute the instructions in all or some of the operating system 417, any applications 419 in the memory 415, any other code necessary to perform the functions in this disclosure, and any other code embodied in hardware or firmware (not shown).

In an embodiment, apparatus 400 may consist of multiple computers 401, along with other devices. A computer 401 may be a mobile computing device such as a smartphone or tablet.

Apparatus 400 may be connected to other systems, computers, servers, devices, and/or the Internet 431 via a local area network (LAN) interface 413.

Apparatus 400 may operate in a networked environment supporting connections to one or more remote computers and servers, such as terminals 441 and 451, including, in general, the Internet and “cloud”. These remote computers and servers, terminals 441 and 451 (as well as other terminals, not shown) may be other quantum computers. Quantum computers may interact with each other over a quantum network. Quantum computers may interact with each other through quantum entanglement. References to the “cloud” in this disclosure may refer to the Internet, which is a world-wide network. “Cloud-based applications” may refer to applications located on a server remote from a user, wherein some or all the application data, logic, and instructions are located on the Internet and are not located on a user’s local device. Cloud-based applications may be accessed via any type of internet connection (e.g., cellular or wi-fi).

Terminals 441 and 451 may be other quantum computers or servers that include many or all the elements described above relative to apparatus 400. The network connections depicted in FIGS. 1-4 include a local area network (LAN) 425 and a wide area network (WAN) 429 but may also include other networks. Computer 401 may include a network interface controller (not shown), which may include a modem 427 and LAN interface or adapter 413, as well as other components and adapters (not shown). When used in a LAN networking environment, computer 401 is connected to LAN 425 through a LAN interface or adapter 413. When used in a WAN networking environment, computer 401 may include a modem 427 or other means for establishing communications over WAN 429, such as Internet 431. The modem 427 and/or LAN interface 413 may connect to a network via an antenna (not shown). The antenna may be configured to operate over Bluetooth, wi-fi, cellular networks, or other suitable frequencies.

It will be appreciated that the network connections shown are illustrative and other means of establishing a communications link between computers may be used. The existence of various well-known protocols such as TCP/IP, Ethernet, FTP, HTTP, and the like is presumed, and the system can be operated in a client-server configuration. The computer may transmit data to any other suitable computer system. The computer may also send computer-readable instructions, together with the data, to any suitable computer system. The computer-readable instructions may be to store the data in cache memory, the hard drive, secondary memory, or any other suitable memory.

Application program(s) 419 (which may be alternatively referred to herein as “plugins,” “applications,” or “apps”) may include computer executable instructions for a quantum authentication program and security protocols, as well as other programs. In an embodiment, one or more programs, or aspects of a program, may use one or more quantum authentication and AI/ML algorithm(s). The various tasks may be related to authenticating a user with a quantum computer.

Computer 401 may also include various other components, such as a battery (not shown), speaker (not shown), a network interface controller (not shown), and/or antennas (not shown).

Any information described above in connection with data 411, and any other suitable information, may be stored in memory 415. One or more of applications 419 may include one or more algorithms that may be used to implement features of the disclosure, and/or any other suitable tasks.

In various embodiments, the invention may be operational with numerous other general purpose or special purpose computing system environments or configurations. Examples of well-known computing systems, environments, and/or configurations that may be suitable for use with the invention in certain embodiments include, but are not limited to, personal computers, servers, multiprocessor systems, microprocessor-based systems, set top boxes, programmable consumer electronics, network PCs, minicomputers, mainframe computers, distributed computing environments that include any of the above systems or devices, quantum computers and the like.

Aspects of the invention may be described in the general context of computer-executable instructions, such as program modules, being executed by a computer. Program modules may include routines, programs, objects, components, data structures, etc., that perform tasks or implement abstract data types. The invention may also be practiced in distributed computing environments where tasks are performed by remote processing devices that are linked through a communications network, e.g., cloud-based applications. In a distributed computing environment, program modules may be in both local and remote computer storage media including memory storage devices.

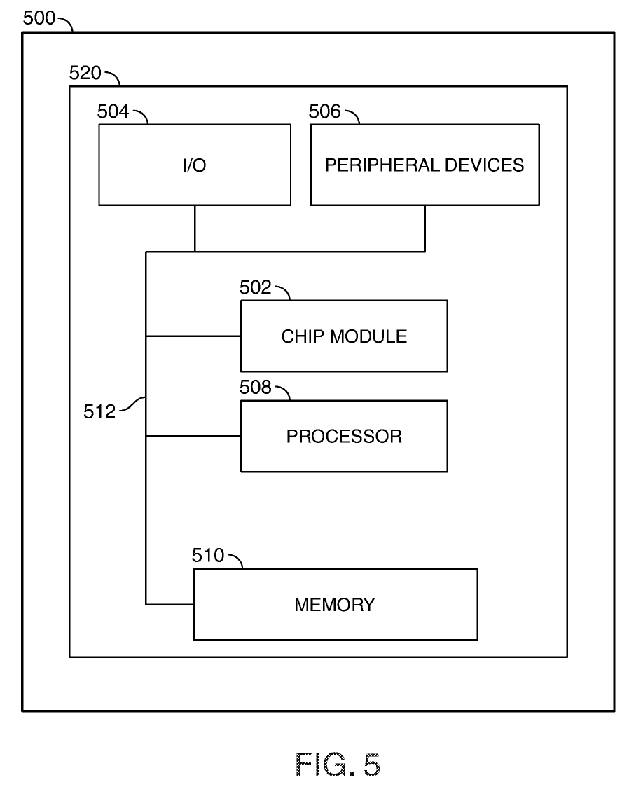

FIG. 5 shows illustrative apparatus 500 that may be configured in accordance with the principles of the disclosure. Apparatus 500 may be a quantum computer, a server, or computer with various peripheral devices 506. Apparatus 500 may include one or more features of the apparatus shown in FIGS. 1-5. Apparatus 500 may include chip module 502, which may include one or more quantum and integrated circuits, and which may include logic configured to perform any other suitable logical operations.

Apparatus 500 may include one or more of the following components: I/O circuitry 504, which may include a transmitter device and a receiver device and may interface with fiber optic cable, coaxial cable, telephone lines, wireless devices, PHY layer hardware, a keypad/display control device, a display (LCD, LED, OLED, etc.), a touchscreen or any other suitable media or devices, peripheral devices 506, which may include other computers, logical processing device 508, which may be quantum based and may compute data information and structural parameters of various applications, and machine-readable memory 510.

Machine-readable memory 510 may be configured to store in machine-readable data structures: machine executable instructions (which may be alternatively referred to herein as “computer instructions” or “computer code”), applications, signals, recorded data, and/or any other suitable information or data structures. The instructions and data may be encrypted.

Components 502, 504, 506, 508 and 510 may be coupled together by a system bus or other interconnections 512 and may be present on one or more circuit boards such as 520. In some embodiments, the components may be integrated into a single chip. The chip may be silicon-based. The chip may be quantum-based.

Thus, provided may be systems and methods relating to use of GenAI to make enhancements to a low resolution digital scan, an electronic document missing information, and/or a low pixel density digital image. Persons skilled in the art will appreciate that the present invention can be practiced by other than the described embodiments, which are presented for purposes of illustration rather than of limitation. The present invention is limited only by the claims that follow.

What is claimed is:

1. A system for enhancement of digital scans of documents using quantum computing to support training an artificial intelligence (“AI”) model, the system comprising:
a quantum computer, said quantum computer for use in enhancing digital scans to prepare a digital scan for use in training an AI model;
a generative artificial intelligence (“GenAI”) model, said GenAI model for providing confirmation of accuracy of enhancements made to digital scans by the quantum computer;
wherein the quantum computer is configured to enhance digital scans of documents when said digital scans comprise at least one corrupt pixel and/or at least one missing pixel for each digital scan, and enhancing digital scans comprise correcting the at least one corrupt pixel and/or at least one missing pixel for each digital scan, said quantum computer being configured to:
receive digital scans of documents, said digital scans comprising pixels;
determine for each digital scan whether the digital scan comprises at least one corrupt pixel and/or at least one missing pixel;
for each digital scan that comprises at least one corrupt pixel and/or at least one missing pixel, convert the pixels of the digital scan into qubits of the digital scan,
propose, using quantum superposition properties and/or quantum entanglement properties of qubits, one or more pixels to enhance the digital scan;
run GenAI model to confirm an accuracy of the one or more pixels proposed to enhance the digital scan using quantum superposition properties and/or quantum entanglement properties of qubits;
when receiving confirmation from the GenAI model, convert the digital scan that comprise at least one corrupt pixel and/or at least one missing pixel into a digital scan that comprises no corrupt pixels and no missing pixels by updating the digital scan with the one or more pixels proposed using quantum superposition properties and/or quantum entanglement properties of qubits; and
after updating one or more digital scans with one or more pixels, provide the one or more digital scans that comprise no corrupt pixels and no missing pixels to train the AI model.

2. The system of claim 1 wherein the GenAI model comprises a generative adversarial network (“GAN”) model, a variational autoencoders (VAE) model, and/or a diffusion model.

3. The system of claim 1 wherein the AI model and the GenAI model are different models.

4. The system of claim 1 wherein:
the AI model and the GenAI model are different models;
the GenAI model is a first GenAI mode; and
the AI model is a second GenAI model.

5. The system of claim 1 wherein the documents comprise a quality level that when scanned generates a digital scan with a low resolution.

6. The system of claim 1 where said quantum computer is further configured to:
maintain a log of changes made to a digital scan; and
revert to a previous version of the digital scan when an error is discovered by the GenAI model.

7. A system for enhancement of electronic documents using quantum computing to support training an artificial intelligence (“AI”) model, the system comprising:
a quantum computer, said quantum computer for use in enhancing electronic documents for use in training an AI model;
a generative artificial intelligence (“GenAI”) model, said GenAI model for providing confirmation of accuracy of enhancements made to electronic documents by the quantum computer;
wherein the quantum computer is configured to enhance electronic documents when said electronic documents comprise a quality that is below a quality threshold, said quality that is below the quality threshold comprising at least one corrupt character and/or at least one missing character, and enhancing electronic documents comprise correcting the at least one corrupt character and/or at least one missing character for each electronic document, said quantum computer being configured to:
receive electronic documents, said electronic documents comprising characters;
determine whether the electronic documents comprise a quality that is below the quality threshold;
for each electronic document that comprises a quality that is below the quality threshold, convert the characters of the electronic document into qubits of the electronic document;
propose, using quantum superposition properties and/or quantum entanglement properties of qubits, one or more characters to enhance a quality of the electronic document;
run GenAI model to confirm an accuracy of the one or more characters proposed to enhance the quality of the electronic document using quantum superposition properties and/or quantum entanglement properties of qubits;
when receiving confirmation from the GenAI model, convert the electronic document with a quality that is below the quality threshold into an electronic document with a quality that is above the quality threshold by updating the electronic document with the one or more characters proposed using quantum superposition properties and/or quantum entanglement properties of qubits, where the electronic document with a quality that is above the quality threshold comprises no corrupt characters and no missing characters; and
provide one or more electronic documents converted from a quality that is below the quality threshold to a quality that is above the quality threshold to train the AI model.

8. The system of claim 7 wherein the GenAI model comprises a generative adversarial network (“GAN”) model, a variational autoencoders (VAE) model, and/or a diffusion model.

9. The system of claim 7, wherein the AI model and the GenAI model are different models.

10. The system of claim 7 wherein:
the AI model and the GenAI model are different models;
the GenAI model is a first GenAI mode; and
the AI model is a second GenAI model.

11. The system of claim 7 where said quantum computer is further configured to:
maintain a log of changes made to an electronic document; and
revert to a previous version of the electronic document when an error is discovered by the GenAI model.

12. A system for enhancement of a digital image using quantum computing to provide an organization with an enhanced digital image, the system comprising:
a quantum computer, said quantum computer for use in enhancing digital images to prepare the digital images for further use;
a generative artificial intelligence (“GenAI”) model, said GenAI model for providing confirmation of accuracy of enhancements made to digital images by the quantum computer;
wherein the quantum computer is configured to enhance digital images when said digital images comprise a pixels per inch (“PPI”) measurement that is less than a PPI threshold, and enhancing digital images comprise increasing PPI by adding at least one pixel for each digital image, said quantum computer being configured to:
receive digital images, said digital images comprising pixels;
determine whether the digital images comprise a PPI that is below the PPI threshold;
for each digital image that comprises a PPI that is below the PPI threshold, convert the pixels of the digital image into qubits of the digital image;
propose, using quantum superposition properties and/or quantum entanglement properties of qubits, one or more additional pixels to enhance the PPI of the digital image;
run GenAI model to confirm an accuracy of the one or more additional pixels proposed to enhance the PPI of the digital image using quantum superposition properties and/or quantum entanglement properties of qubits;
when receiving confirmation from the GenAI model, convert the digital image with a PPI that is below the PPI threshold into a digital image with a PPI that is above the PPI threshold by updating the digital image with the one or more additional pixels proposed using quantum superposition properties and/or quantum entanglement properties of qubits; and
provide to the organization one or more digital images converted from a PPI that is below the PPI threshold to a PPI that is above the PPI threshold.

13. The system of claim 12 wherein the GenAI model comprises a generative adversarial network (“GAN”) model, a variational autoencoders (VAE) model, and/or a diffusion model.

14. The system of claim 12 where said quantum computer is further configured to:
maintain a log of changes made to a digital image; and
revert to a previous version of the digital image when an error is discovered by the GenAI model.

15. The system of claim 12 wherein the PPI threshold is 68 PPI.

16. The system of claim 12 wherein the PPI threshold is 92 PPI.

17. The system of claim 12 wherein the PPI threshold is 175 PPI.

18. The system of claim 12 wherein the PPI threshold is 235 PPI.

19. The system of claim 12 wherein the PPI threshold is 295 PPI.

20. The system of claim 12 wherein the PPI threshold is 395 PPI.
